(19) United States
(12) Patent Application Publication
(10) Pub. No.: US 2006/0241249 A1
(43) Pub. Date: Oct. 26, 2006

(54) Curable resin composition and process for production thereof

(76) Inventors: Mitsuhiro Kasai, Hyogo (JP); Hitoshi Tamai, Hyogo (JP); Shintaro Komitsu, Hyogo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/546,520

(22) PCT Filed: Feb. 20, 2004
(86) PCT No.: PCT/JP04/02045

§ 371 Date: Mar. 2, 2006

(30) Foreign Application Priority Data
Feb. 28, 2003 (JP) 2003-053164
Jul. 31, 2003 (JP) 2003-204290

(51) Int. Cl. C08F 30/08; C08G 77/60

(52) U.S. Cl. 525/477; 526/279; 526/319; 526/328

(57) ABSTRACT

The present invention provides a curable resin composition excellent in weather resistance and transparency, satisfactory in handling workability, low in modulus and excellent in elongation properties, a process for production of the curable resin composition, and a resin composition to be used in the process for production of the curable resin composition. In the process for production of the curable resin composition comprising an oxyalkylene polymer (A) having one or more reactive silicon groups and a polymer (B) having one or more reactive silicon groups and having a molecular chain substantially composed of alkyl(meth)acrylate monomer units each containing an alkyl group having 1 to 24 carbon atoms, the curable resin composition is obtained by mixing a reaction mixture, obtained through the polymerization of the polymer (B) in an organic polymer plasticizer (C), with the oxyalkylene polymer (A).

### TECHNICAL FIELD

The present invention relates to a curable composition comprising a curable organic polymer and a process for production thereof.

### BACKGROUND ART

A curable composition, comprising an oxyalkylene polymer (polymer (A)) capable of cross-linking curing by forming siloxane bonds, and an acrylate and/or methacrylate polymer (polymer (B)) capable of cross-linking curing by forming siloxane bonds, is used for sealants and adhesives because the curable composition is cured to yield elastic articles excellent in weather resistance and adhesion.

As the process for production of a curable composition, comprising an oxyalkylene polymer (polymer (A)) capable of cross-linking curing by forming siloxane bonds, and an acrylate and/or methacrylate polymer (polymer (B)) capable of cross-linking curing by forming siloxane bonds, there have hitherto been known the following processes and others: a process in which the polymer (A) is mixed and dissolved in a solution of the polymer (B), and thereafter the solvent is removed by devolatilization (Japanese Patent Laid-Open No. 63-112642); a process in which the polymer (B) is polymerized in the polymer (A) (Japanese Patent Laid-Open Nos. 59-78223 and 60-228517-3); and a process in which the polymer (B) is polymerized in a phthalate or a hydrocarbon plasticizer and thereafter mixed with the polymer (A) (Japanese Patent Laid-Open No. 59-122541). However, the compatibility between the polymer (A) and the polymer (B) is not necessarily sufficient, and accordingly there has been a constraint on the acrylate monomer and/or the methacrylate monomer to be used for the polymer (B). The process in which the polymer (A) and the polymer (B) are directly mixed or the process in which the polymer (B) is polymerized in the polymer (A) is also problematic for handling workability because the viscosity is greatly increased in any of these processes. Because inclusion of the polymer (B) tends to provide a high modulus and a low degree of elongation, some improvement has been demanded in the application as sealant in which particular properties such as a low modulus and a high elongation properties are important. A constraint comes from the fact that by making the polymer (B) have a higher molecular weight for the purpose of such improvement, the elongation is improved to some extent, but the viscosity is drastically increased to degrade the handling workability.

### DISCLOSURE OF THE INVENTION

The object of the present invention is to provide a process for production of a curable resin composition excellent in weather resistance and transparency, satisfactory in handling workability, low in modulus and excellent in elongation properties, and a resin composition to be used in the process for production of the curable resin composition.

As a result of an investigation on the process for production of the curable resin composition comprising the polymer (A) and the polymer (B), the present inventors have achieved the present invention by finding a process in which a resin composition, obtained by polymerizing a monomer for the polymer (B) in an organic polymer plasticizer (C), is mixed with the polymer (A).

More specifically, a first aspect of the present invention is a process for production of a curable resin composition which comprises an oxyalkylene polymer (A) having one or more silicon-containing functional groups capable of cross-linking by forming siloxane bonds and a polymer (B) having one or more silicon-containing functional groups capable of cross-linking by forming siloxane bonds and having a molecular chain substantially comprising alkyl acrylate monomer units and/or alkyl methacrylate monomer units each containing an alkyl group having 1 to 24 carbon atoms, the process being characterized in that a resin composition, obtained by polymerizing the monomers to be the polymer (B) in an organic polymer plasticizer (C), is mixed with the oxyalkylene polymer (A).

A second aspect of the present invention is a reaction mixture comprising the polymer (B) having one or more silicon-containing functional groups capable of cross-linking by forming siloxane bonds and having a molecular chain substantially obtained by polymerizing a monomer composed of the alkyl acrylate and/or the alkyl methacrylate each containing an alkyl group having 1 to 24 carbon atoms in an organic polymer plasticizer (C), wherein the reaction mixture is a resin composition to provide the aforementioned curable composition when mixed with the oxyalkylene polymer (A) having one or more silicon-containing functional groups capable of cross-linking by forming siloxane bonds. A third aspect of the present invention is a curable composition produced by this process.

The main chain structure of the organic polymer plasticizer (C) is preferably an oxyalkylene polymer, and more preferably essentially the same as the oxyalkylene polymer (A).

The oxyalkylene polymer (A) preferably has a number average molecular weight of 6,000 or more and an Mw/Mn value of 1.6 or less.

The oxyalkylene polymer (A) has preferably a main chain structure obtained by polymerizing an alkylene oxide in the presence of an initiator by use of a double metal cyanide complex as a catalyst.

The polymer (B) preferably has a number average molecular weight of 3,000 or more.

### BEST MODE FOR CARRYING OUT THE INVENTION

As an oxyalkylene polymer constituting the polymerized main chain of the component (A) in the present invention, a main chain having the repeating units represented by the general formula (I) may be used, and an oxypropylene polymer is preferable because of easy availability: [symbol]
R¹—O [symbol] (I)
wherein R¹ represents divalent alkylene group having 1 to 4 carbon atoms. The oxypropylene polymer may be a linear chain, a branched chain, or a mixture thereof. The oxypropylene polymer may include other monomer units, but it is preferable that the monomer unit represented by the above formula is present in the polymer in a content of 50 wt % or more, and preferably 80 wt % or more.

The oxyalkylene polymer, as the component (A) of the present invention, containing one or more silicon-containing functional groups (herein after referred to as reactive silicon groups, as the case may be) capable of cross-linking by forming siloxane bonds is preferably a polymer which is obtained by introducing the reactive silicon groups into an oxyalkylene polymer having functional groups.

The oxyalkylene polymer preferably has a high molecular weight and a small molecular weight distribution (Mw/Mn) from the viewpoints of the viscosity, workability and the elongation of the cured article. Specifically, the molecular weight is preferably 6,000 or more, more preferably 10,000 or more, and furthermore preferably 15,000 or more. The molecular weight distribution (Mw/Mn) is also preferably 1.6 or less, and more preferably 1.5 or less.

An oxypropylene polymer having such a molecular weight and a molecular weight distribution is hardly obtainable by means of an anion polymerization process using caustic alkali or a process for chain elongation reaction of this polymer, but can be obtained by means of the processes in which used are a cesium metal catalyst, porphyrin/aluminum complex catalysts exemplified in Japanese Patent Laid-Open Nos. 61-197631, 61-215622, 61-215623, 61-218632 and the like, double metal cyanide complex catalysts exemplified in Japanese Patent Publication Nos. 46-27250, 59-15336 and the like, and catalysts composed of polyphosphazene salts exemplified in Japanese Patent Laid-Open No. 10-273512. Among these polymerization processes, particularly preferable are the processes in which an alkylene oxide is polymerized in the presence of an initiator by use of a double metal cyanide complex as a catalyst on the practical grounds that these processes scarcely involve problems such as coloring. The molecular weight distribution of the reactive silicon group-containing oxyalkylene polymer depends on the molecular weight distribution of the corresponding polymer prior to introduction of reactive silicon groups, and accordingly it is preferable that the molecular weight distribution of the polymer prior to the introduction of reactive silicon groups is as narrow as possible.

The introduction of the reactive silicon groups can be made on the basis of processes well known in the art. More specifically, for example, the following processes may be cited. Here, it may be noted that a case of an oxyalkylene polymer obtained by use of a double metal cyanide complex catalyst is described, for example, in Japanese Patent Laid-Open No. 3-72527; and a case of an oxyalkylene polymer obtained by use of a polyphosphazene salt and active hydrogen as catalysts is described, for example, in Japanese Patent Laid-Open No. 11-60723.

(1) An unsaturated group-containing oxyalkylene polymer is obtained by reacting an oxyalkylene polymer having at the terminals thereof functional groups such as hydroxy groups with an organic compound having an active group exhibiting reactivity to these functional groups and an unsaturated group, or by copolymerizing an oxyalkylene polymer with an unsaturated group-containing epoxy compound. Thereafter, the reaction product thus obtained is hydrosilylated by reacting a reactive silicon group-containing hydrosilane with the reaction product.

(2) With an unsaturated group-containing oxyalkylene polymer obtained in the same manner as in the process (1), a compound having a mercapto group and a reactive silicon group is reacted.

(3) With an oxyalkylene polymer having at the terminals thereof a functional group (hereinafter, referred to as the Y functional group) such as a hydroxy group, an epoxy group or an isocyanate group, a compound having a functional group exhibiting reactivity to the Y functional group (hereinafter, referred to as the Y′ functional group) and a reactive silicon group is reacted.

Specific examples of the silicon compound having the Y′ functional group may include: amino group-containing silanes such as γ-(2-aminoethyl)aminopropyltrimethoxysilane, γ-(2-aminoethyl)aminopropylmethyldimethoxysilane and γ-aminopropyltriethoxysilane; mercapto group-containing silanes such as γ-mercaptopropyltrimethoxysilane and γ-mercaptopropylmethyldimethoxysilane; epoxysilanes such as γ-glycidoxypropyltrimethoxysilane and β-(3,4-epoxycyclohexyl)ethyltrimethoxysilane; vinylically unsaturated group-containing silanes such as vinyltriethoxysilane, γ-methacryloyloxypropyltrimethoxysilane and γ-acryloyloxypropylmethyldimethoxysilane; chlorine atom-containing silanes such as γ-chloropropyltrimethoxysilane; isocyanate group-containing silanes such as γ-isocyanatepropyltriethoxysilane, γ-isocyanatepropylmethyldimethoxysilane and γ-isocyanatepropyltrimethoxysilane; and hydrosilanes such as methyldimethoxysilane, trimethoxysilane, methyldiethoxysilane and triethoxysilane. However, the silicon compound having the Y′ functional group is not limited to these.

The number average molecular weight of the component (A) as referred to in the present specification is defined as follows. The molecular weight concerned is defined as a number average molecular weight which is obtained by directly measuring the end-group concentration with the aid of a titrimetric analysis based on the hydroxyl value measurement method in conformity with JISK 1557 and the iodine value measurement method in conformity with JISK 0070, wherein the structure of the polyether oligomer is taken into account. Alternatively, the molecular weight concerned can be obtained by deriving a calibration curve between the molecular weight relative to polystyrene standard obtained by the GPC measurement which is a general method of relative measurement of the number average molecular weight and the above end-group molecular weight, and by thereby converting the GPC molecular weight to the end-group molecular weight. The Mw/Mn values were obtained on the basis of the GPC measurement.

The reactive silicon group possessed by the reactive silicon group-containing oxyalkylene polymer as the component (A) of the present invention is represented, for example, by the general formula (II): 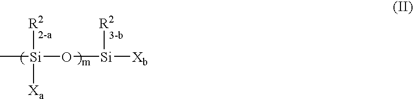
wherein R²s are different or the same groups selected from the group consisting of a monovalent substituted or nonsubstituted organic group having 1 to 24 carbon atoms and a triorganosiloxy group; Xs are hydroxy groups or different or the same hydrolyzable groups; a is an integer of 0, 1 or 2, b is an integer of 0, 1, 2 or 3 with the proviso that the relation, Σa+b≧1, is satisfied; and m is an integer of 0 to 19.

A reactive silicon group preferable from the viewpoint of economic efficiency is a group represented by the general formula (III): 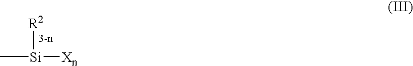
wherein R²s and Xs are the same as above, and n is an integer of 1, 2 or 3.

Specific examples of the hydrolyzable group in formula (II) may include a halogen atom, a hydrogen atom, an alkoxy group, an acyloxy group, a ketoxymate group, an amino group, an amido group, an aminooxy group, a mercapto group and an alkenyloxy group. Among these groups, alkoxy groups such as a methoxy group and an ethoxy group are preferable from the viewpoint of moderate hydrolyzability. One to three hydrolyzable groups and/or hydroxy groups can combine to one silicon atom, and it is preferable that Σa+b falls within a range from 1 to 5. When two or more hydrolyzable groups and/or hydroxy groups are combined in a reactive silicon group, they may be the same or different.

Specific examples of R² in formula (II) may include: alkyl groups such as a methyl group and an ethyl group; cycloalkyl groups such as a cyclohexyl group; aryl groups such as a phenyl group; and aralkyl groups such as a benzyl group. R² may also be a triorganosiloxy group. Among these groups, a methyl group is particularly preferable.

The reactive silicon group may be formed with one or more silicon atoms; when silicon atoms connected by siloxane bonds or the like are involved, it may be formed with about twenty silicon atoms.

More specific examples of the reactive silicon group may include a trimethoxysilyl group, a triethoxysilyl group, a triisopropoxysilyl group, a methyldimethoxysilyl group, a methyldiethoxysilyl group and a methyldiisopropoxysilyl group. Among these groups, a methyldimethoxysilyl group is particularly preferable from the viewpoints of reactivity, storage stability, mechanical properties after curing and the like.

The polymer as the component (B) of the present invention is a polymer which comprises alkyl acrylate monomer units and/or alkyl methacrylate monomer units each containing an alkyl group having 1 to 24 carbon atoms, wherein silicon-containing functional groups capable of cross-linking by forming siloxane bonds are bonded to the terminals and/or side chain positions of the polymer in a proportion at least one per one molecule of the polymer.

The alkyl acrylate monomer unit and/or the alkyl methacrylate monomer unit, each containing an alkyl group having 1 to 24 carbon atoms, as the monomer units in the above polymer, is represented by the general formula (IV): 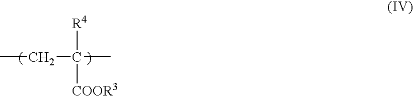
wherein R⁴ represents a hydrogen atom or a methyl group, and R³ represents an alkyl group having 1 to 24 carbon atoms.

Examples of R³ in above general formula (IV) may include alkyl groups having 1 to 24 carbon atoms such as a methyl group, an ethyl group, a propyl group, a n-butyl group, a t-butyl group, a 2-ethylhexyl group, a nonyl group, a lauryl group, a tridecyl group, a cetyl group, a stearyl group and a biphenyl group. The monomer species represented by the monomer unit of general formula (IV) may be used each alone or in combinations of two or more thereof.

As the alkyl acrylate monomer, those well known in the art can be widely used. Examples of such alkyl acrylates may include: methyl acrylate, ethyl acrylate, n-propyl acrylate, n-butyl acrylate, isobutyl acrylate, tert-butyl acrylate, n-hexyl acrylate, heptyl acrylate, 2-ethylhexyl acrylate, nonyl acrylate, decyl acrylate, undecyl acrylate, lauryl acrylate, tridecyl acrylate, myristyl acrylate, cetyl acrylate, stearyl acrylate, behenyl acrylate and biphenyl acrylate. Also, as the alkyl methacrylate monomer unit, those well known in the art can be widely used. Examples of such alkyl methacrylates may include: methyl methacrylate, ethyl methacrylate, n-propyl methacrylate, n-butyl methacrylate, isobutyl methacrylate, tert-butyl methacrylate, n-hexyl methacrylate, heptyl methacrylate, 2-ethylhexyl methacrylate, nonyl methacrylate, decyl methacrylate, undecyl methacrylate, lauryl methacrylate, tridecyl methacrylate, myristyl methacrylate, cetyl methacrylate, stearyl methacrylate, behenyl methacrylate and biphenyl methacrylate.

The molecular chain of the polymer (B) substantially comprises one or more types of alkyl acrylate monomer units and/or alkyl methacrylate monomer units. Herein, the expression “substantially comprises the above monomer units” means that the proportion of the alkyl acrylate monomer units and/or alkyl methacrylate monomer units present in the polymer (B) exceeds 50 wt %, and is preferably 70 wt % or more; in the polymer (B), in addition to the alkyl acrylate monomer unit and/or alkyl methacrylate monomer unit, other monomer untis having copolymerizability with these monomer units may be included. Examples of such other monomer units may include: acrylic acids such as acrylic acid and methacrylic acid; amide group-containing monomers such as acrylamide, methacrylamide, N-methylolacrylamide and N-methylolmethacrylamide; epoxy group-containing monomers such as glycidyl acrylate and glycidyl methacrylate; amino group-containing monomers such as diethylaminoethyl acrylate, diethylaminoethyl methacrylate and aminoethyl vinyl ether; polyoxyethylene group-containing monomers such as polyoxyethylene acrylate and polyoxyethylene methacrylate; and other monomer units such as acrylonitrile, styrene, α-methylstyrene, alkyl vinyl ether, vinyl chloride, vinyl acetate, vinyl propionate and ethylene.

The monomer composition of the polymer (B) is selected according to the intended use and purpose; for example, when the intended use and purpose demand strength, the preferred monomer composition is the one having a high glass transition temperature, and it is recommended to select a monomer composition that yields the polymer (B) having a glass transition temperature of 0° C. or higher, more preferably 20° C. or higher. On the contrary, when the viscosity and the workability are important, the preferred composition is the one having a relatively low glass transition temperature.

With respect to the molecular weight of the polymer component (B), those polymers (B) having a number average molecular weight of 500 to 100,000 relative to polystyrene standard as measured by GPC may be used. When the polymer (B) is a high molecular weight polymer having a molecular weight of 3,000 or more, the compatibility between the polymer component (A) and the polymer component (B) tends to be decreased, and hence the mixture composed of the polymer component (A) and the polymer component (B) tends to be opaque and highly viscous. When the molecular weight of the polymer (B) is 5,000 or more, such a tendency becomes highly obvious, while when the molecular weight of the polymer (B) is 15,000 or more, such a tendency becomes further highly obvious. However, according to the curable resin composition obtained by the process of the present invention, a transparent composition can be obtained even when the molecular weight of the polymer (B) is 3,000 or more, so that the process of the present invention is particularly preferable when the molecular weight of the polymer (B) is 3,000 or more. Also when the polymer (B) is a polymer including an alkyl acrylate monomer unit and/or an alkyl methacrylate monomer unit each containing an alkyl group having 1 to 6 carbon atoms and including an alkyl acrylate monomer unit and/or an alkyl methacrylate monomer unit each containing an alkyl group having 7 to 9 carbon atoms, the above mentioned tendency becomes highly obvious for the molecular weight concerned of 5,000 or more, so that the process of the present invention is particularly preferable.

The polymer (B) may be obtained by means of the common vinyl polymerization process or the like. The polymerization reaction concerned may be carried out by adding, for example, the above monomers, a radical initiator and a chain transfer agent in the organic polymer plasticizer (C) and by allowing the mixture thus obtained to react at 50 to 150° C.

Examples of such a radical initiator may include azobisisobutylonitrile and benzoyl peroxide; examples of such a chain transfer agent may include mercaptanes such as n-dodecylmercaptane, t-dodecylmercaptane and laurylmercaptane, and halogen-containing compounds. A solvent is not necessarily needed, but it is preferable to use, for example, nonreactive solvents such as ethers, hydrocarbons and esters when a solvent is used.

Various processes are available for the introduction of the reactive silicon group into the polymer (B). Examples of such processes may include the following processes. However, the process concerned is not particularly limited to these examples.

(i) A process in which an alkyl acrylate monomer and/or an alkyl methacrylate monomer is polymerized in the presence of a reactive silicon group-containing mercaptane as a chain transfer agent to introduce the reactive silicon groups into the molecular terminals.

(ii) A process in which an alkyl acrylate monomer and/or an alkyl methacrylate monomer is polymerized in the presence of a compound (for example, acrylic acid) having a mercapto group and a reactive functional group (other than a silicon group, hereinafter referred to as a Y group) as a chain transfer agent; thereafter the thus produced polymer is reacted with a compound having functional groups (hereinafter referred to as Y′ groups) capable of reacting with the reactive silicon group and the Y group (for example, a compound having an isocyanate group and a —Si(OCH₃)₃ group) to introduce the reactive silicon groups into the molecular terminals.

(iii) A process in which an alkyl acrylate monomer and/or an alkyl methacrylate monomer is polymerized by using as an initiator a reactive silicon group-containing azobisnitrile compound or a reactive silicon group-containing disulfide compound to introduce the reactive silicon groups into the molecular terminals.

(iv) A process in which an alkyl acrylate monomer and/or an alkyl methacrylate monomer is polymerized by means of the living radical polymerization process to introduce the reactive silicon groups into the molecular terminals.

(v) A process in which a compound having a polymerizable unsaturated bond and a reactive silicon group is copolymerized with an alkyl acrylate monomer and/or an alkyl methacrylate monomer by selecting the polymerization conditions such as the used amount proportion of the monomers, the amount of the chain transfer agent, the amount of the radical initiator and the polymerization temperature so that one or more of the reactive silicon groups may be introduced per one molecule of the copolymer.

Examples of the reactive silicon group-containing mercaptane used as the chain transfer agent described in (i) may include γ-mercaptopropyltrimethoxysilane, γ-mercaptopropylmethyldimethoxysilane and γ-mercaptopropyltriethoxysilane.

As the examples of the Y group and the Y′ group described in (ii), there are combinations of various groups; for example, an amino group, a hydroxy group or a carboxylic acid group may be cited as the Y group, and an isocyanate group may be cited as the Y′ group. As described in Japanese Patent Laid-Open Nos. 54-36395, 1-272654 and 2-214759, there may be cited another example such that the Y group is an ally group and the Y′ group is a silicon hydride group (H—Si). In this case, the Y and Y′ groups can be bonded to each other through the hydrosilylation reaction in the presence of a group VIII transition metal.

Examples of the reactive silicon group-containing azobisnitrile compound and the reactive silicon group-containing disulfide compound described in (iii) may include an alkoxysilyl group-containing azobisnitrile compound and an alkoxysilyl group-containing disulfide compound described in Japanese Patent Laid-Open Nos. 60-23405 and 62-70405, and the like.

Examples of the process described in (iv) may include a process described in Japanese Patent Laid-Open No. 9-272714 and the like.

Examples of the compound having a polymerizable unsaturated bond and a reactive silicon group described in (v) may include a monomer represented by the general formula (V):
CH₂═C(R⁴)COOR⁵—[Si(R²₂₋ₐ)(Xₐ)O]ₘSi(R²_{3-b})X_{b} (V)
wherein R⁵ represents a divalent alkylene group having 1 to 6 carbon atoms, and R², R⁴, X, a, b and m are the same as described above, or a monomer represented by the general formula (VI)
CH₂═C(R⁴)—[Si(R²₂₋ₐ)(Xₐ)O]ₘSi(R²_{3-b})X_{b} (VI)
wherein R², R⁴, X, a, b and m are the same as described above, namely, γ-methacryloxypropylalkylpolyalkoxysilanes such as γ-methacryloxypropyltrimethoxysilane, γ-methacryloxypropylmethyldimethoxysilane and γ-methacryloxypropyltriethoxysilane; γ-acryloxypropylalkylpolyalkoxysilanes such as γ-acryloxypropyltrimethoxysilane, γ-acryloxypropylmethyldimethoxysilane and γ-acryloxypropyltriethoxysilane; and vinylalkylpolyalkoxysilanes such as vinyltrimethoxysilane, vinylmethyldimethoxysilane and vinyltriethoxysilane.

The number of the reactive silicon groups contained in the acrylic polymer (B) is required to be at least one or more, on average, per one molecule of the acrylic polymer (B). For the purpose of obtaining sufficient curability, the number concerned is preferably 1.1 or more, and particularly preferably 1.5 or more. The bonding position of the reactive silicon groups may be the terminals or the side chains of the polymer chain.

As for the type of the reactive silicon group contained in the acrylic polymer (B), a silicon group having on the silicon atom thereof 1 to 3 silicon groups having reactivity can be used.

In the case where the component (B) of the present invention has an insufficient compatibility with the oxypropylene polymer as the component (A) to lead to a low transparency, the process of the present invention provides a favorable effect on the improvement of the transparency.

As for the weight ratio (A)/(B) between the polymer (A) and the polymer (B) of the present invention, the production is possible over any wide range of the weight ratio. In general, as (A)/(B) becomes relatively small, mechanical strength and high weather resistance are provided. Depending on the molecular weight and the glass transition temperature of the polymer (B), when (A)/(B) is 1.5 or less, the two-component mixture composed of the polymer (A) and the polymer (B) is generally increased in viscosity, and particularly when (A)/(B) is 1.0 or less, it becomes hard to handle the mixture because the tendency to be high in viscosity be comes remarkable. However, the use of the process of the present invention can overcome such a problem to provide a favorable effect.

The mechanical properties of a cured article derived from the curable resin composition obtained according to the process of the present invention attain such properties as a lower modulus and a higher elongation than those obtained by a conventional production process. The reasons for attaining such advantageous effects are not clear at present, but these advantageous effects are favorable for applications as sealants where the low modulus and high elongation properties are particularly important.

In the present invention, there may be used general plasticizers other than the organic polymer plasticizer (C). Examples of such general plasticizers may include: phthalates such as dibutyl phthalate, diheptyl phthalate, di(2-ethylhexyl) phthalate, butyl benzyl phthalate, butyl phthalyl butyl glycolate; nonaromatic dibasic acid esters such as dioctyl adipate and dioctyl sebacate; and phosphates such as tricresyl phosphate and tributyl phosphate. Although phthalate plasticizers are preferable from the viewpoints of performance and economic efficiency, phthalate plasticizers, in particular, general-purpose di(2-ethylhexyl) phthalate tends to be avoided recently because of the problems involving safety and health, so that it is preferable to use high molecular weight plasticizers in place of low molecular weight plasticizers on the grounds of safety and health. Examples of such high molecular weight plasticizers may include: polyester plasticizers such as polyesters between dibasic acid and polyhydric alcohols; liquid acrylic resin plasticizers having a molecular chain comprising an alkyl acrylate monomer unit and/or an alkyl methacrylate monomer unit and having no silicon-containing functional groups; polyether plasticizers such as polypropylene glycol and the derivatives thereof; and polystyrene plasticizers such as poly-α-methylstyrene and polystyrene. Specific examples may include PPG3000 (trade name: Actocole P-23; a polyether polyol manufactured by Mitsui Takeda Chemicals, Inc., with a molecular weight of about 3000), Excenol 5030 (a polyether polyol manufactured by Asahi Glass Co., Ltd., with a Mw value of about 5100), an oxypropylene polymer having allyl ether groups at both terminals thereof with Mn=5200 and Mw/Mn=1.6; and SGO, an acrylic oligomer (manufactured by Johnson Polymer, Inc. and Toagosei Co., Ltd.) Polymers having a molecular chain comprising an alkyl acrylate monomer unit and/or an alkyl methacrylate monomer unit and having no silicon-containing functional groups can be easily obtained by polymerizing in the same manner as for the acrylic polymer (B) except that no compounds containing reactive silicon groups are used. The use of acrylic resin plasticizers is preferable because high durabilities such as weather resistance, and among such plasticizers, the SGO oligomer is particularly preferable because the molecular weight thereof is relatively low and the viscosity thereof is low to make its handling easy.

The plasticizer in the present invention is used for the purpose of complementing the deficiency of the organic polymer plasticizer (C), and accordingly it may be used or not be used. The total used amount of the organic polymer plasticizer (C) and the plasticizers other than that can be selected within a range from 0 to 300 parts by weight in relation to 100 parts by weight of the sum amount of the polymer (A) and the polymer (B), but it is preferably set within a range from 0 to 100 parts by weight. The plasticizers may be used each alone or can be used in combinations of two or more thereof.

No constraint is imposed on the main chain structure of the organic polymer plasticizer (C) in the present invention, but examples of such a main chain structure may include an oxyalkylene polymer, an acrylic polymer and a hydrocarbon polymer. The main chain structure of the organic polymer plasticizer (C) used is preferably the same as that of the polymer component (A) used. In other words, an oxyalkylene polymer is preferable.

Among the oxyalkylene polymers, preferable are those oxyalkylene polymers which have essentially the same main chain structures as that of the oxyalkylene polymer (A) because the compatibilities of such polymers tend to be satisfactory. Because a reactive silicon group-containing oxypropylene polymer is preferable as the polymer (A) of the present invention, an oxypropylene polymer plasticizer is likewise preferable as the organic polymer plasticizer (C). For example, a PPG (polypropylene glycol) or PPT (polypropylene triol) having a molecular weight of 500 to 20000 can be used. Because a PPG or PPT having a molecular weight of 5000 or less is low in viscosity, the viscosity can be made to fall within a range compatible with easy handling even after the polymerization of the polymer (B). Examples of such an oxypropylene polymer may include PPG3000 (trade name: Actocol P-23; a polyether polyol manufactured by Mitsui Takeda Chemicals Co., Ltd., with a molecular weight of about 3000), Excenol 5030 (a polyether polyol manufactured by Asahi Glass Co., Ltd., with a Mw value of about 5100) and an oxypropylene polymer having allyl ether groups at both terminals thereof with Mn=5200 and Mw/Mn=1.6.

In the curable composition obtained in the present invention, there may be used a curing accelerating catalyst, a filler, other additives and the like, added thereto according to need.

As the curing accelerating catalyst, common silanol condensation catalysts may be used. Examples of such a curing accelerator may include organotin compounds, organic acid salts of metallic tin, which are non-organotin compounds, or combination of amine compounds therewith, and non-tin compounds. Specific examples of the organotin compounds may include: dibutyltin dicarboxylates such as dibutyltin dilaurate and dibutyltin bis(alkyl maleate); dialkyltin alkoxide derivatives such as ditutyltin dimethoxide and dibutyltin diphenoxide; dialkyltin intramolecular coordinate derivatives such as dibutyltin diacetylacetonate and dibutyltin acetoacetate; a reaction mixture between dibutyltin oxide and an ester compound; a reaction mixture between dibutyltin oxide and a silicate compound; and derivatives of tetravalent dialkyltin oxides such as oxy derivatives of these dialkyltin oxide derivatives. However, the organotin compounds are not limited to these examples. Specific examples of the non-organotin compounds may include divalent tin carboxylates such as tin octylate, tin oleate, tin stearate and tin versatate. The combinations of these divalent tin carboxylates with amines are high in activity, and are thereby more preferable from the viewpoint of being capable of reducing the used amounts thereof. Examples of the non-tin compounds as the curing accelerating catalysts may include organic acids such as organic carboxylic acids, organic sulfonic acids and acidic phosphates. Examples of the organic carboxylic acids may include: aliphatic carboxylic acids such as acetic acid, oxalic acid, butyric acid, tartaric acid, maleic acid, octylic acid and oleic acid; and aromatic carboxylic acids such as phthalic acid and trimellitic acid; the aliphatic arboxylic acids being preferable from the viewpoint of the activity. Examples of the organic sulfonic acids may include toluene sulfonic acid and styrene suflonic acid. Examples of the acidic phosphates may include the following organic acidic phosphates. The organic acidic phosphate compounds are preferable from the viewpoints of the compatibility and the curing catalyst activity. The organic acidic phosphate compounds are represented by the formula:
(R—O)_{d}—P(═O)(—OH)_{3-d}
wherein d is 1 or 2, and R represents an organic residue. Specific examples concerned are shown below, but the organic acidic phosphate compounds are not limited to these examples shown below.
(CH₃O)₂—P(═O)(—OH),
(CH₃O)—P(═O)(—OH)₂,
(C₂H₅O)₂—P(═O) (—OH),
(C₂H₅O)—P(═O)(—OH)₂,
(C₃H₇O)₂—P(═O)(—OH),
(C₃H₇O)—P(═O)(—OH)₂,
(C₄H₉O)₂—P(═O)(—OH),
(C₄H₉O)—P(═O) (—OH)₂,
(C₈H₁₇O)₂—P(═O)(—OH),
(C₈H₁₇O)—P(═O)(—OH)₂,
(C₁₀H₂₁O)₂—P(═O)(—OH)
(C₁₀H₂₁O)—P(═O)(—OH)₂,
(C₁₃H₂₇O)₂—P(═O)(—OH),
(C₁₃H₂₇O)—P(═O)(—OH)₂,
(C₁₆H₃₃O)₂—P(═O)(—OH),
(C₁₆H₃₃O)—P(═O)(—OH)₂,
(HO—C₆H₁₂O)₂—P(═O)(—OH),
(HO—C₆H₁₂O)—P(═O)(—OH)₂,
(HO—C₈H₁₆O)—P(═O)(—OH),
(HO—C₈H₁₆O)—P(═O)(—OH)₂,
[(CH₂OH)(CHOH)O]₂—P(═O)(—OH),
[(CH₂OH)(CHOH)O]—P(═O)(—OH)₂,
[(CH₂OH)(CHOH)C₂H₄O]₂—P(═O)(—OH),
[(CH₂OH)(CHOH)C₂H₄O]—P(═O)(—OH)₂

The combinations of these organic acids with amines are high in activity, and are thereby more preferable from the viewpoint of being capable of reducing the used amounts thereof. Among the combinations of the organic acids with amines, the combination of an acidic phosphate with an amine and the combination of an organic carboxylic acid with an amine, particularly, the combination of an organic acidic phosphate with an amine and the combination of an aliphatic carboxylic acid with an amine are preferable from the viewpoints of the higher activity and the rapid curability.

Examples of the amine compounds may include butyl amine, octyl amine, lauryl amine, dibutyl amine, monoethanolamine, diethanolamine, triethanolamine, diethylenetriamine, triethylenetetramine, oleyl amine, cyclohexyl amine, benzyl amine, diethylaminopropyl amine, xylylene diamine, triethylene diamine, guanidine, diphenyl guanidine, 2,4,6-tris(dimethylaminomethyl)phenol, morpholine, N-methylmorpholine, 2-ethyl-4-methylimidazole and 1,8-diazabicyclo(5,4,0)undecene-7 (DBU).

The non-tin metal salts can also be used, and examples of such metal salts may include metal carboxylates, in which the carboxylic acid components are octylic acid, oleic acid, naphthenic acid and stearic acid, such as calcium carboxylates, zirconium carboxylates, iron carboxylates, vanadium carboxylates, bismuth carboxylates, bismuth salts including bismuth tris(2-ethylhexoate) and bismuth tris(neodecanoate), lead carboxylates, titanium carboxylates and nickel carboxylates. The combinations of these carboxylates with the aforementioned amines are preferable from the viewpoint of being capable of reducing the used amount because the activity is increased in the same manner as in tin carboxylates.

Examples of the organic non-tin metal compounds may include organometallic cpmpounds each containing a group 3B metal or a group 4A metal; organic titanate compounds, organoaluminum compounds, organozirconium compounds, organoboron compounds and the like are preferable from the viewpoint of the activity, but the organic non-tin metal compounds are not limited to these examples.

Examples of the aforementioned organic titanate compounds may include: titanium alkoxides such as tetraisopropyl titanate, tetrabutyl titanate, tetramethyl titanate, tetra(2-ethylhexyl titanate), triethanolamine titanate; chelate compounds including titanium chelates such as titanium tetraacetylacetonate, titanium ethylacetoacetate, octylene glycolate and titanium lactate.

Examples of the aforementioned organoaluminum compounds may include: aluminumalkoxides such as aluminumisopropylate, mono-sec-butoxyaluminum diisopropylate and aluminum sec-butyrate; aluminum chelates such as aluminum trisacetylacetonate, aluminum trisethylacetoacetate and diisopropoxyaluminum ethylacetoacetate.

Examples of the aforementioned zirconium compounds may include: zirconium alkoxides such as zirconium tetraisopropoxide, zirconium tetra-n-propylate and zirconium normal-butyrate; and zirconium chelates such as zirconium tetraacetylacetonate, zirconium monoacetylacetonate, zirconium bisacetylacetonate, zirconium acetylacetonate bisethylacetoacetate and zirconium acetate.

These organic titanate compounds, organoaluminum compounds, organozirconium compounds, organoboron compounds and the like can be used in combinations thereof; however, particularly the combinations of these compounds with the aforementioned amines or acidic phosphate compounds can increase the activity, so that such combinations are preferable from the viewpoint of being capable of reducing the used amount of the catalyst and are more desirable from the viewpoint of the regulation between the high-temperature curability and the work life at room temperature.

The used amounts of these curing accelerators may be usually selected according to the intended applications and performances; however, the used amounts concerned are preferably 0.01 to 10 parts by weight and more preferably, from the view point of the cost, 0.05 to 5 parts by weight in relation to 100 parts by weight of the sum amount of the polymer (A) and the polymer (B).

In the present invention, fillers, other additives and the like may be used as additives according to need. Examples of the fillers may include: ground calcium carbonate, light calcium carbonate, colloid calcium carbonate, kaolin, talc, silica, titanium oxide, aluminum silicate, magnesium oxide, zinc oxide and carbon black. When a filler is used, the used amount thereof is preferably in a range from 5 to 300 parts by weight in relation to 100 parts by weight of the sum amount of the polymer (A) and the polymer (B), and more preferably in a range from 10 to 150 parts by weight from the viewpoint of the balance between the mechanical properties and the viscosity. Examples of the aforementioned other additives may include antisagging agents such as hydrogenated castor oil and organic bentonites, colorants, antiaging agents and adhesion-imparting agents. Also, for the purpose of improving the adhesion and the storage stability, there may be blended one or combinations of two or more of silane coupling agents such as
N-(β-aminoethyl)-γ-aminopropylmethyldimethoxysilane,
γ-aminopropyltrimethoxysilane,
γ-aminopropyltriethoxysilane, vinyltrimethoxysilane,
γ-glycidoxypropyltrimethoxysilane,
γ-glycidoxypropylmethyldimethoxysilane,
N-(β-aminoethyl)-γ-aminopropyltrimethoxysilane,
γ-acryloylpropyltrimethoxysilane and
γ-acryloylpropylmethyldimethoxysilane. The reaction products obtained by reacting these silane coupling agents in advance may also be blended. According to need, an epoxy resin and a curing agent thereof, a viscosity improver, other additives and the like may also be optionally blended. Examples of such other additives may include pigments, various antiaging agents and ultraviolet absorbers.

The curable composition of the present invention, when exposed to the atmosphere, forms a three dimensional network structure through the action of moisture to be cured into a solid article having rubbery elasticity. The curable composition of the present invention is useful as an elastic sealant, and can be used as a sealant for building structure, ships, vehicles, roads and the like. Because the curable composition of the present invention can adhere, singly or with the aid of an primer, to a wide range of substrates such as those made of glass, porcelain, wood, metals and resin molded articles, it can also be used as various types of sealing compositions and adhesive compositions. The curable composition obtained by the process according to the present invention can be effectively applied particularly to highly weather resistant sealants and adhesives, clear sealants and adhesives, and high strength sealants and adhesives.

### BEST MODE FOR CARRYING OUT THE INVENTION

For the purpose of more clearly presenting the present invention, description will be made below on the present invention with reference to specific Examples, but the present invention is not limited to these Examples.

### EXAMPLE 1

In an atmosphere of nitrogen, to 183 g of PPG3000 (trade name: Actocole P-23; a polyether polyol manufactured by Mitsui Takeda Chemicals, Inc., with a molecular weight of about 3000) heated to 105° C., there was added dropwise over a period of 4 hours a solution composed of 68.5 g of butyl acrylate, 14.5 g of methyl methacrylate, 15 g of stearyl methacrylate, 2 g of γ-methacryloxypropylmethyldimethoxysilane, 0.5 g of V-59 manufactured by Wako Pure Chemical Industries, Ltd. and 15 g of toluene, to yield an acrylic polymer having a number average molecular weight of about 18,000. The polymerization conversion rate obtained from the nonvolatile component thereof was 99% (the conditions for the nonvolatile component measurement: 120° C. for 1 hour). Then, the solvent was completely removed by devolatilization under reduced pressure (at 120° C. for 2 hours), to yield a colorless, transparent and solvent-free polymer composition (PPG3000: the acrylic polymer=55:30 by weight ratio). The viscosity thereof at 23° C. was 30 Pa·s. (Polymer Composition A)

### EXAMPLE 2

In an atmosphere of nitrogen, to 183 g of PPG3000 heated to 105° C., there was added dropwise over a period of 4 hours a solution composed of 55.5 g of butyl acrylate, 25 g of 2-ethylhexyl acrylate, 15 g of methyl methacrylate, 4.5 g of γ-methacryloxypropylmethyldimethoxysilane, 2.2 g of V-59 manufactured by Wako Pure Chemical Industries, Ltd. and 15 g of toluene, to yield an acrylic polymer having a number average molecular weight of about 8,000. The polymerization conversion rate obtained from the nonvolatile component thereof was 99% (the conditions for the nonvolatile component measurement: 120° C. for 1 hour). Then, the solvent was completely removed by devolatilization under reduced pressure (at 120° C. for 2 hours), to yield a colorless, transparent and solvent-free polymer composition (PPG3000: the acrylic polymer=55:30 by weight ratio). The viscosity thereof at 23° C. was 2.1 Pa·s. (Polymer Composition B)

### SYNTHESIS EXAMPLE 1

Propylene oxide was polymerized by using a polyoxypropylene glycol having a molecular weight of about 2000 as an initiator and a zinc hexacyanocobaltate glyme complex catalyst, to yield a polyoxypropylene glycol having an average molecular weight of 20,000 as measured on the basis of a terminal group analysis. Then, there was added a methanol solution of 1.2 equivalents of NaOMe in relation to the hydroxy groups of this hydroxy group-terminated polyether oligomer, and the methanol was distilled off. There was further added allyl chloride to convert the terminal hydroxy groups into allyl groups. Then, hexane and water were added to extract and remove the salts, and the hexane was devolatilized under reduced pressure from the hexane solution phase to yield a purified ally-terminated polyoxypropylene. To this product, 30 μl of a platinum divinyldisiloxane complex (an isopropanol solution of 3 wt % in terms of platinum) was added, to this reaction mixture DMS (dimethoxymethylsilane) was slowly added dropwise under stirring, and the reaction mixture was allowed to react at 90° C. for 2 hours to yield a pale-yellow, transparent, and reactive silicon group-containing polyoxypropylene polymer. From a ¹H-NMR analysis of the obtained polymer, the introduction rate of the reactive silicon group into the terminals was confirmed to be 77%. The Mw/Mn value of the obtained polymer was 1.2. The viscosity thereof was 45.0 Pa·s at 23° C. (Polymer A)

### SYNTHESIS EXAMPLE 2

A mixture composed of polypropylene glycol (number average molecular weight: 2,500) and polypropylene triol (number average molecular weight: 3,000) as a starting material was treated with sodium methoxide, and then underwent a molecular-weight jump reaction by use of methylene chloride, thereafter allyl chloride was reacted with the reaction mixture to convert the terminal hydroxy groups into unsaturated groups. With this ally group-terminated polyoxyalkylene, methyldimethoxysilane of an equimolar amount in relation to the number of the allyl groups, was reacted in the presence of an isopropanol solution of chloroplatinic acid, to yield a yellow, transparent liquid polymer. From an IR analysis and a ¹H-NMR analysis of the obtained polymer, it was confirmed that the terminal allyl groups were deleted and the reactive silicon groups were introduced. The Mw/Mn value of the obtained polymer was 2.3, and the viscosity thereof was 20 Pa·s at 23° C. (Polymer B)

### COMPARATIVE SYNTHESIS EXAMPLE 1

Polymerization was carried out in the same manner as in Example 1 except that 60 g of toluene was used in place of 183 g of PPG3000, to yield a toluene solution of an acrylic polymer (Polymer C) having a number average molecular weight of about 18,000. In this solution, Polymer A was dissolved so as for the weight ratio of the Polymer A to the acrylic polymer (Polymer C) to be 70:30, and then the solvent was completely distilled off by devolatilization under reduced pressure (at 120° C. for 2 hours) to yield a pale-yellow, transparent and solvent-free polymer composition (Polymer Composition C). The viscosity of Polymer Composition C at 23° C. was 70 Pa·s.

### COMPARATIVE SYNTHESIS EXAMPLE 2

Polymerization was carried out in the same manner as in Example 2 except that 60 g of toluene was used in place of 183 g of PPG3000, to yield a toluene solution of an acrylic polymer (Polymer D) having a number average molecular weight of about 8,000. In this solution, Polymer B was dissolved so as for the weight ratio of the Polymer B to the acrylic polymer (Polymer D) to be 70:30, and then the solvent was completely distilled off by devolatilization under reduced pressure (at 120° C. for 2 hours) to yield a non-transparent, solvent-free polymer composition. The viscosity of the polymer composition at 23° C. was 27 Pa·s. (Polymer Composition D)

### EXAMPLE 3

Mixing of 70 parts by weight of Polymer A obtained in Synthesis Example 1 with 85 parts by weight of Polymer Composition A obtained in Example 1 resulted in a transparent mixture. The handling workability in this mixing was satisfactory because the mixture was low in viscosity. Then, 120 parts by weight of calcium carbonate (manufactured by Shiraishi Kogyo Kaisha, Ltd., trade name: Hakuenka CCR), 20 parts by weight of titanium oxide (manufactured by Ishihara Sangyo Kaisha, Ltd., trade name: Tipaque R-820), 2 parts by weight of a thixotropy providing agent (manufactured by Kusumoto Chemicals, Ltd., trade name: Disparlon 6500), 1 part by weight of a benzotriazole ultraviolet absorber (manufactured by Ciba Specialty Chemicals Ltd., trade name: TINUVIN 327) and 1 part by weight of a hindered amine photostabilizer (manufactured by Sankyo Co., Ltd., tradename: SANOL LS-770) were weighed out and mixed in the aforementioned mixture, and the mixture thus obtained was fully kneaded and subsequently three times passed through a small triple paint roll. Then, 2 parts by weight of vinyltrimethoxysilane, 3 parts by weight of an aminosilane compound (manufactured by Japan Unicar Co., Ltd., trade name: A-1120) and 2 parts by weight of a curing accelerator (manufactured by Nitto Kasei Co., Ltd., trade name: Neostann U-220) were added to the rolled mixture and the mixture thus obtained was kneaded to yield a 3 mm thick sheet-like product. The product was cured at 23° C. for 3 days, and additionally, at 50° C. for 4 days. Then, a dumbbell for tensile test (JIS No. 3 dumbbell) was prepared.

### EXAMPLE 4

In place of 70 parts by weight of Polymer A of Synthesis Example 1 and 85 parts by weight of Polymer Composition A of Example 1, both used in Example 3, 70 parts by weight of Polymer B of Synthesis Example 2 and 85 parts by weight of Polymer Composition B of Example 2 were used to yield a transparent mixture. The handling workability in this mixing was satisfactory because the mixture was low in viscosity. A dumbbell for tensile test was prepared in the same manner as in Example 3 except for what was described above.

### COMPARATIVE EXAMPLE 1

In place of 70 parts by weight of Polymer A of Synthesis Example 1 and 85 parts by weight of Polymer Composition A of Example 1, both used in Example 3, 100 parts by weight of Polymer Composition C obtained in Comparative Synthesis Example 1 and 55 parts by weight of PPG3000 as the organic polymer plasticizer (C) were used to yield a transparent mixture. The handling workability in this mixing was unsatisfactory because the mixture was high in viscosity. A dumbbell for tensile test was prepared in the same manner as in Example 3 except for what was described above.

### COMPARATIVE EXAMPLE 2

In place of the polymer composition C in Comparative Example 1, Polymer Composition D obtained in Comparative Synthesis Example 2 was used to yield a transparent mixture. The handling workability in this mixing was satisfactory because the mixture was low in viscosity. A dumbbell for tensile test was prepared in the same manner as in Comparative Example 1 except for what was described above.

### COMPARATIVE EXAMPLE 3

In a toluene solution of the acrylic polymer (Polymer C) of Comparative Synthesis Example 1, PPG3000 was dissolved as the organic polymer plasticizer (C) so as for the weight ratio of PPG3000 to the acrylic polymer (Polymer C) to be 55:30, and then the solvent was completely distilled off by devolatilization under reduced pressure (at 120° C. for 2 hours) to yield a solvent-free polymer composition (Polymer Composition E). Then, in place of Polymer Composition A in Example 3, Polymer composition E was used to yield a transparent mixture. The handling workability in this mixing was satisfactory because the mixture was low in viscosity. A dumbbell for tensile test was prepared in the same manner as in Example 3 except for what was described above.

### COMPARATIVE EXAMPLE 4

In a toluene solution of the acrylic polymer (Polymer D) of Comparative Synthesis Example 2, PPG3000 was dissolved as the organic polymer plasticizer (C) so as for the weight ratio of PPG3000 to the acrylic polymer (Polymer D) to be 55:30, and then the solvent was completely distilled off by devolatilization under reduced pressure (at 120° C. for 2 hours) to yield a solvent-free polymer composition (Polymer Composition F). Then, in place of Polymer Composition E in Comparative Example 3, Polymer composition F was used to yield a transparent mixture. The handling workability in this mixing was satisfactory because the mixture was low in viscosity. A dumbbell for tensile test was prepared in the same manner as in Comparative Example 3 except for what was described above.

TABLE 1

| | | Example 1; | Example 2; |
|---|---|---|---|
| | | Polymer | Polymer |
| Component | | Composition A | Composition B |
| C | PPG3000 | 183 | 183 |
| Raw material | Methyl methacrylate | 14.5 | 15 |
| monomers for B | Butyl acrylate | 68.5 | 55.5 |
| | 2-Ethylhexyl acrylate | | 25 |
| | Stearyl methacrylate | 15 | |
| | γ-Methacryloxypropylmethyldimethoxysilane | 2 | 4.5 |
| | V-59 | 0.5 | 2.2 |

| | | |
|---|---|---|
| Number average molecular weight of B | 18000 | 8000 |
| Viscosity of a composition obtained | 30 | 2.1 |
| by polymerizing B in C (Pa · s) | | |
| Appearance of a composition obtained | Colorless, | Colorless, |
| by polymerizing B in C | transparent | transparent |

TABLE 2

| | | | | | Comp. | Comp. | Comp. | Comp. |
|---|---|---|---|---|---|---|---|---|
| | Component | | Example 3 | Example 4 | ex. 1 | ex. 2 | ex. 3 | ex. 4 |
| Composition | A | Polymer A | 70 | | | | 70 | |
| | | Polymer B | | 70 | | | | 70 |
| | | Polymer | 85 | | | | | |
| | | composition A | | | | | | |
| | B | Polymer | | 85 | | | | |
| | polymerized | composition B | | | | | | |
| | in C | | | | | | | |
| | A + B | Polymer | | | 100 | | | |
| | | composition C | | | | | | |
| | | Polymer | | | | 100 | | |
| | | composition D | | | | | | |
| | B + C | Polymer | | | | | 85 | |
| | | composition E | | | | | | |
| | | Polymer | | | | | | 85 |
| | | composition F | | | | | | |
| | C | PPG3000 | | | 55 | 55 | | |

| | | | | | | | |
|---|---|---|---|---|---|---|---|
| Tensile | 50% Modulus (MPa) | 0.12 | 0.19 | 0.18 | 0.29 | 0.19 | 0.28 |
| physical | 100% Modulus (MPa) | 0.20 | 0.34 | 0.31 | 0.53 | 0.32 | 0.52 |
| properties | Tensile strength at break | 1.86 | 1.66 | 1.94 | 1.83 | 1.96 | 1.80 |
| | (MPa) | | | | | | |
| | Elongation at break (%) | 1040 | 600 | 765 | 460 | 760 | 450 |

| | | | | | | |
|---|---|---|---|---|---|---|
| Handling workability in | Satisfactory | Satisfactory | Unsatisfactory | Satisfactory | Satisfactory | Satisfactory |
| mixing | | | | | | |
| Appearance of mixture | Transparent | Transparent | Transparent | Transparent | Transparent | Transparent |

### INDUSTRIAL APPLICABILITY

The process of the present invention can provide a process for production of a curable resin composition which is excellent in handling workability, transparency and weather resistance, and is also flexible and excellent in elongation properties.

1. A process for production of a curable resin composition which comprises an oxyalkylene polymer (A) having one or more silicon-containing functional groups capable of cross-linking by forming siloxane bonds and a polymer (B) having one or more silicon-containing functional groups capable of cross-linking by forming siloxane bonds and having a molecular chain substantially comprising alkyl acrylate monomer units and/or alkyl methacrylate monomer units each containing an alkyl group having 1 to 24 carbon atoms, the process being characterized in that the curable resin composition is obtained by mixing a reaction mixture, obtained by polymerizing said monomers for said polymer (B) in an organic polymer plasticizer (C), with said oxyalkylene polymer (A).

2. The process for production of the curable resin composition according to claim 1, in which the main chain structure of the organic polymer plasticizer (C) is an oxyalkylene polymer.

3. The process for production of the curable resin composition according to claim 2, in which the main chain structures of the oxyalkylene polymer (A) and the organic polymer plasticizer (C) are essentially the same.

4. The process for production of the curable resin composition according to claim 1, in which the number average molecular weight and the Mw/Mn value of the oxyalkylene polymer (A) are 6,000 or more and 1.6 or less, respectively.

5. The process for production of the curable resin composition according to claim 1, in which the oxyalkylene polymer (A) has a main chain structure obtained by polymerizing an alkylene oxide in the presence of an initiator by use of a double metal cyanide complex as a catalyst.

6. The process for production of the curable resin composition according to claim 1, in which the number average molecular weight of the polymer (B) is 3,000 or more.

7. The process for production of the curable resin composition according to claim 1, in which the polymer (B) is a copolymer comprising (1) alkyl acrylate monomer units and/or alkyl methacrylate monomer units each containing an alkyl group having 1 to 6 carbon atoms and (2) alkyl acrylate monomer units and/or alkyl methacrylate monomer units each containing an alkyl group having 7 to 9 carbon atoms.

8. A resin composition, wherein the resin composition is a reaction mixture comprising a polymer (B) having one or more silicon-containing functional groups capable of cross-linking by forming siloxane bonds and having a molecular chain substantially obtained by polymerizing a monomer composed of an alkyl acrylate and/or an alkyl methacrylate each containing an alkyl group having 1 to 24 carbon atoms and wherein the resin composition is used for mixing with an oxyalkylene polymer (A) having one or more silicon-containing functional groups capable of cross-linking by forming siloxane bonds.

9. The resin composition for use in mixing with the oxyalkylene polymer (A) according to claim 8, in which the main chain structure of the organic polymer plasticizer (C) is an oxyalkylene polymer.

10. The resin composition for use in mixing with the oxyalkylene polymer (A) according to claim 9, in which the main chain structures of the oxyalkylene polymer (A) and the organic polymer plasticizer (C) are essentially the same.

11. A curable resin composition prepared by mixing a reaction mixture comprising a polymer (B), which has one or more silicon-containing functional groups capable of cross-linking by forming siloxane bonds and has a molecular chain substantially obtained by polymerizing a monomer composed of an alkyl acrylate and/or an alkyl methacrylate, each containing an alkyl group having 1 to 24 carbon atoms, with an oxyalkylene polymer (A) having one or more silicon-containing functional groups capable of cross-linking by forming siloxane bonds.
